(19) United States
(12) Patent Application Publication
(10) Pub. No.: US 2020/0250601 A1
(43) Pub. Date: Aug. 6, 2020

(54) Method for Rescheduling of Non-Critical Activities in a Schedule

(71) Applicant: Rifat Sonmez, Ankara (TR)

(72) Inventor: Rifat Sonmez, Ankara (TR)

(21) Appl. No.: 16/262,937

(22) Filed: Jan. 31, 2019

(51) Int. Cl. G06Q 10/06

(52) U.S. Cl. CPC G06Q 10/06312; G06Q 10/0633

(57) ABSTRACT

A computerized scheduling method for rescheduling of the non-critical activities in a schedule when the duration or start time of a non-critical is changed, and the change does not increase the project duration. The method determines the non-critical activities that are impacted by the schedule change and only reschedules the impacted activities. The impacted non-critical activities are rescheduled by partial scheduling in which only the start and finish times that will change are calculated along with the floats. The method can be used for resource leveling, cash flow management, time cost trade-off analysis and for similar problems of project management in which rescheduling of non-critical activities are required.

### FIELD OF INVENTION

The invention relates to computerized scheduling systems, specifically rescheduling of non-critical activities in a schedule.

### BACKGROUND

Critical path method (CPM) is a project network technique which is commonly used in project scheduling, controlling, and management. CPM is widely used worldwide for all types of projects, including construction, engineering, software development, aerospace and defense. As a result of demand from multiple industries, numerous computer algorithms and software that were based on CPM were developed for project scheduling and management.

CPM consists of the following steps: first the activities are identified and their durations are assigned, then the precedence relations among the activities are defined, and finally CPM calculations are performed. The CPM calculations are usually carried out through a forward pass and a backward pass to determine the early start times, early finish times, late start times, late finish times and floats of the activities. The critical path is the longest sequence of tasks in the project network which determines the shortest possible time to complete the project. The critical activities which are on the critical path cannot be delayed without delaying the project completion time. However, the start dates of the non-critical activities can be shifted within their early and late start dates without delaying the project.

During execution of a project, an activity duration may change due to many reasons such as; resource constraints, management decisions, and factors impacting the productivity. The CPM method requires a full forward and backward pass calculation for all activities to reschedule the early start times, early finish times, late start times, late finish times and floats of the activities, even if the duration of a single non-critical activity is changed. Although the forward and backward pass calculations are straightforward, the calculations may require significant processing time for some large projects including thousands of activities and complex precedence relations. On the other hand, due to iterative and repetitive nature of most of the optimization algorithms, any variation in the duration and/or start time of the activities require incessant rescheduling of the project for potential changes. Accordingly, reiterative rescheduling of the projects using CPM method is acknowledged as the computational bottleneck of the optimization problems.

CPM only considers time optimization, it does not consider cost or resource optimization. Time-cost tradeoff problem aims to optimize the cost along with the time by including different activity execution modes, representing different duration and cost alternatives. Due to its practical relevance many heuristic and meta-heuristic methods have been developed for the time-cost tradeoff problem. For a given set of activity execution modes, some methods may increase the durations of the non-critical activities without making them critical to decrease the total project cost. However, in classical scheduling methods, a duration change of a single activity will require a full forward and full backward pass calculations to reflect the impact of the change in the schedule. For a large size projects, execution of several duration changes may require a significant amount of processing time for forward and backward pass calculations.

Since CPM does not consider optimization of resources, alternative methods were developed for different optimization purposes. Resource leveling methods aim to minimize the fluctuations in the resource diagram or the peak resources by shifting the start dates of the non-critical activities within their early and late start dates without changing the project completion time. Majority of leveling methods uses multiple shifts of non-critical activities. Similarly, cash flow management methods may perform shifting the start dates of the non-critical activities within their early and late start dates to improve the cash flow of the project. As each shift of a non-critical activity will require a full forward pass and backward pass to reschedule the non-critical activities, majority of the leveling and cash flow management methods require a significant amount of processing time and cannot handle large scale projects.

Current scheduling techniques require rescheduling of all activities when the duration or start time of a non-critical activity is changed and the change does not increase the project duration. However, these types of changes will not impact all activities and do not require rescheduling of all activities. Hence, there is a need for a method which only reschedules the non-critical activities that are impacted by a duration change or a shift of a non-critical activity to ease computational efforts. Current scheduling techniques also perform full scheduling calculations and determine all of the start and finish times when there is a change in a non-critical activity. However, even a non-critical activity is impacted by a schedule change, some of its start and finish times may not change. Hence, there is a also a need for a scheduling method which performs partial scheduling and only calculates the start and finish times that will change. The present invention aims to provide a novel method for rescheduling of non-critical activities that overcomes or at least alleviates the aforementioned problems.

### SUMMARY

The present invention comprises a novel computerized scheduling method for rescheduling of the non-critical activities in a schedule when the duration or start time of a non-critical activity (or multiple non-critical activities) is changed and the change does not increase the project duration. The method of the present invention first determines the non-critical activities that are impacted by a change in the duration or the start time of an activity. The method then only reschedules the activities that are impacted by the change. During rescheduling of the activities that are impacted by the change, the method only updates the required start and finish times by performing novel non-critical partial forward pass and non-critical partial backward pass scheduling methods.

The method of the present invention can be used to reschedule non-critical activities efficiently, when there is change in the duration or the start time of a non-critical activity, and the change does not increase the project duration. The invention can be adopted to the time-cost optimization, resource leveling and cash flow management problems to improve computational performance of the heuristic and meta-heuristic methods for handling large scale projects.

The aforementioned advantages of the invention are more fully explained and illustrated by the accompanying drawings and the detailed description. The drawings and the examples are included for explanation purpose and do not restrict the scope of the invention as claimed.

### BRIEF DESCRIPTION OF THE DRAWINGS

FIG. 1 is a flowchart for one embodiment of the invention which illustrates the method for rescheduling the non-critical activities when the duration of a non-critical activity is changed.

FIG. 2 is a flowchart which illustrates the method for rescheduling the non-critical activities when the start time of a non-critical activity is shifted.

FIG. 3 is an example CPM schedule which is used to describe the invention.

FIG. 4 illustrates one embodiment of the invention for partial forward pass, when the duration of a non-critical activity is changed.

FIG. 5 illustrates the result of partial forward pass, when the duration of a non-critical activity is changed.

FIG. 6 illustrates partial backward pass, when the duration of a non-critical activity is changed, in accordance with the method.

FIG. 7 illustrates the embodiment of the invention for partial forward pass, when the start time of a non-critical activity is shifted.

FIG. 8 illustrates the results of partial forward pass, when the start time of a non-critical activity is shifted.

FIG. 9 illustrates partial backward pass, when the start time of a non-critical activity is shifted, in accordance with the method.

### DETAILED DESCRIPTION OF THE INVENTION

All terms used herein are used in accordance with their ordinary meanings, unless the context or definition clearly indicates otherwise. Also, unless indicated otherwise, except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

When a change is made on a non-critical activity, the current scheduling techniques reschedule all of the activities to update the schedule. However, since a change in a non-critical activity will not change start and finish times of critical activities, and may not change start and finish times of some non-critical activities, rescheduling all activities is not an efficient way to update the schedule when the schedule change does not increase the project duration. The present disclosure presents a method which only reschedules the non-critical activities that are impacted by a duration change or a start time shift. Another limitation of the current scheduling techniques is that they require calculation of Early Start (ES), Early Finish (EF), Late Start (LS), and Late Finish (LF) dates for all of the activities when there is a change in the schedule of a non-critical activity. The method of the present invention only calculates the start and finish dates that are impacted by the schedule change by using novel scheduling features such as partial forward pass scheduling, and partial backward pass scheduling.

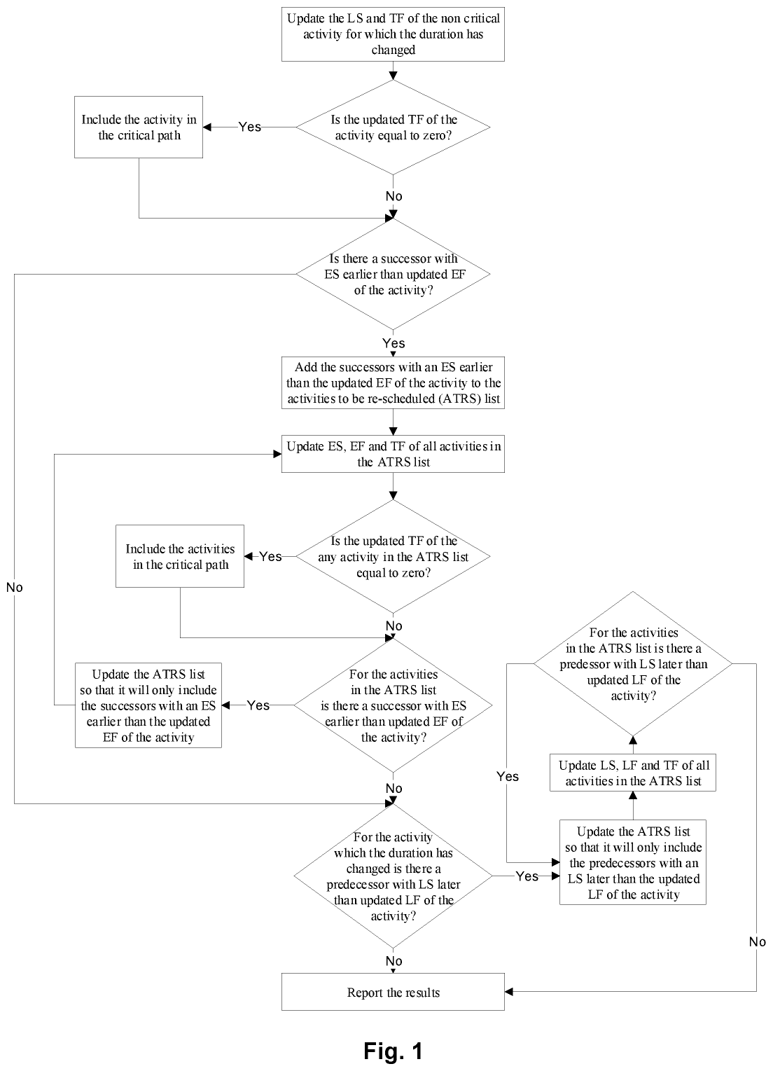

The present invention is suitable for rescheduling of the non-critical activities when the change made on a non-critical activity does not change the project completion time. The changes may be a duration change, a shift in the start time, or a shift in the finish time, or any change which does not change the project duration. Referring to FIG. 1, when the duration of a non-critical activity is changed, the method of the invention first determines the updated EF of the activity, by adding the revised duration to the ES. If the updated EF of the activity is not later than the LF of the activity, the duration change will not change the project completion time, hence the method is suitable for rescheduling. Along with the EF, the method determines the updated late start LS by subtracting the revised duration from the LF, and calculates the updated total float (TF) by subtracting the EF from the LF. Since the duration change made does not impact the ES and LF of the activity only EF, LS, and TF are updated for this activity. The updated non-critical activity is included in the critical path if the updated TF is equal to zero.

The method of the present invention determines the non-critical successors of the updated activity that are impacted by the first schedule update. A successor needs to be rescheduled if the ES of the successor is earlier than the updated EF of the rescheduled activity. Hence all the successors with an ES earlier than the updated EF of the rescheduled activity are added to the activities to be rescheduled (ATRS) list, and the updated activity is removed from the list.

In the partial forward pass scheduling part of the method, the ES, EF, and the TFs of all succeeding activities that are included in the ATRS list are updated. Since the duration change made does not impact the LF of the rescheduled activity, it will not impact the LS and LF of the succeeding activities. The ES of the activities in ATRS list are scheduled so that these activities start immediately after the updated EF time of the first rescheduled activity. The EF of the all activities in the ATRS list are determined by adding their durations to their ES, and the TFs of the activities are updated by subtracting their EF from the LF. The activities with an updated zero float are included in the critical path.

The procedure is repeated to identify the non-critical activities which are impacted by rescheduling of the activities in the ATRS list. The ATRS list is updated so that it will include the successors of the previous ATRS list with an ES earlier than the updated EF of the preceding activity, and updated activities are removed from the list. The ES, EF times and TFs of all of the required activities are updated by partial forward pass, and the procedure is repeated until all the succeeding activities that are impacted by the duration change are updated as shown in FIG. 1.

In the partial backward pass scheduling part of the method, the LF, LS, and the TFs of all preceding activities that are impacted by the duration change are updated. The predecessors with an LF later than the updated LS of the rescheduled activity are impacted by the duration change, hence these activities are rescheduled. Since the duration change made does not impact the ES of the activity for which the duration has changed, it will not impact the EF and ES of the preceding activities. The method of the present invention determines the activities that are impacted by the duration change and performs partial backward pass scheduling until all the impacted preceding activities are updated similar to the forward pass as shown in FIG. 1. In the final stage of the partial backward pass, the activities with an updated zero float are included in the critical path.

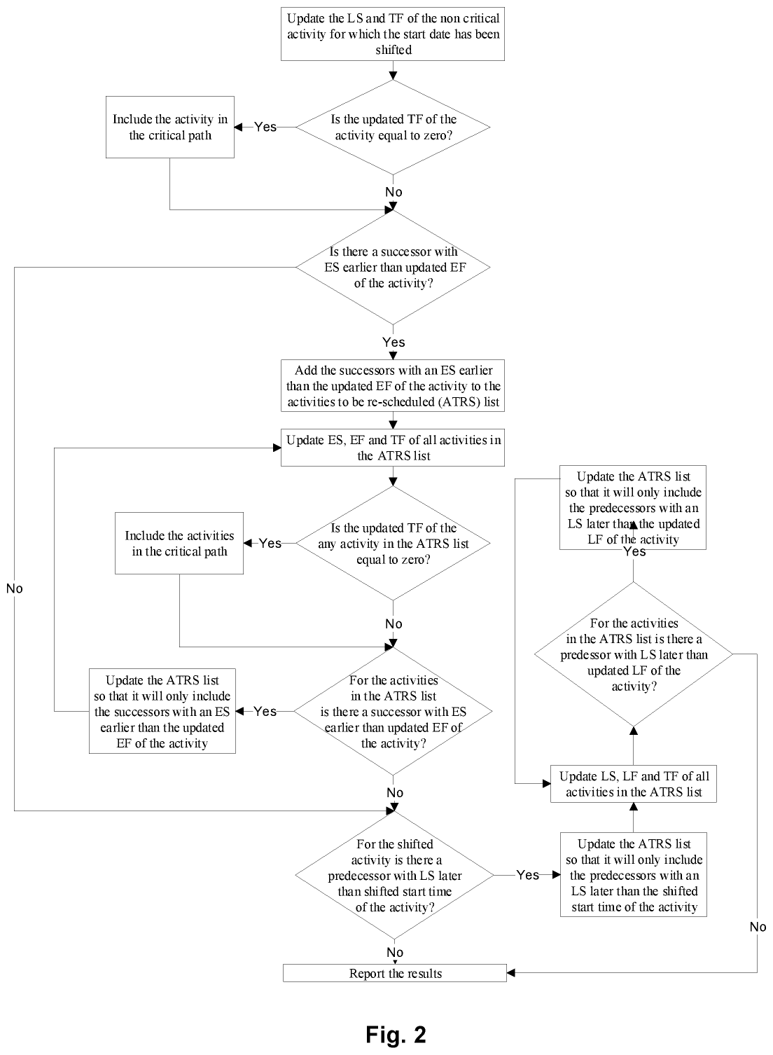

The method of the present invention can be applied to rescheduling of non-critical activities due to a shift in the start time of a non-critical activity similarly. Referring to FIG. 2, when the start time of a of a non-critical activity is shifted within its early and late start times, the method of the invention first determines the updated EF of the activity, by adding the duration of the activity to its shifted start time. The method then determines the updated TF by subtracting the EF from the updated LF. The updated non-critical activity is included in the critical path if the updated TF is equal to zero.

The method determines the non-critical successors of the rescheduled activity that are impacted by the first schedule update. All the successors with an ES earlier than the updated EF of the rescheduled activity are added to the activities to be rescheduled (ATRS) list, and the updated activity is removed from the list. In the partial forward pass scheduling part of the method, the ES, EF, and the TFs of all succeeding activities that are included in the ATRS list are updated. The activities with an updated zero float are included in the critical path. The ATRS list is updated so that it will include the successors of the previous ATRS list with an ES earlier than the updated EF of the preceding activity, and updated activities are removed from the list. The EF, LF times and TFs of all of the activities are updated by partial forward pass, and the procedure is repeated until all the succeeding activities that are impacted due to the shift in the start time are updated as shown in FIG. 2.

In the partial backward pass scheduling, the LF, LS, and the TFs of all predecessors with a LF later than the shifted start time of the rescheduled activity are rescheduled first, and the activities with an updated zero float are included in the critical path. The method of the present invention determines the activities that are impacted due to the shift in the start time, and performs partial backward pass scheduling until all the impacted preceding activities are updated as shown in FIG. 2.

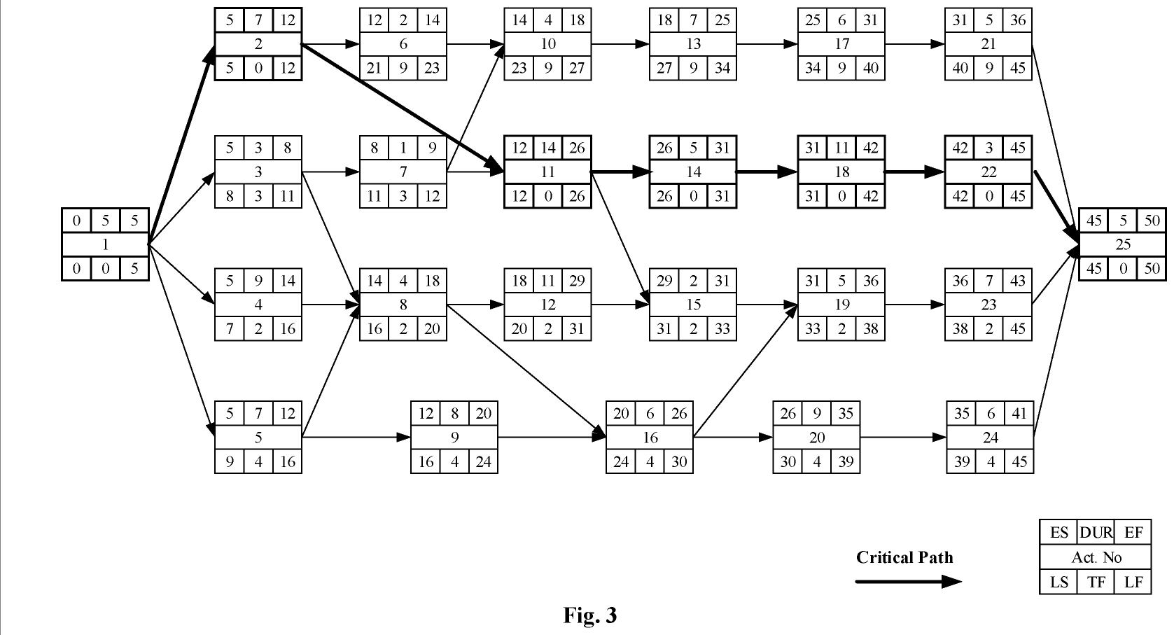

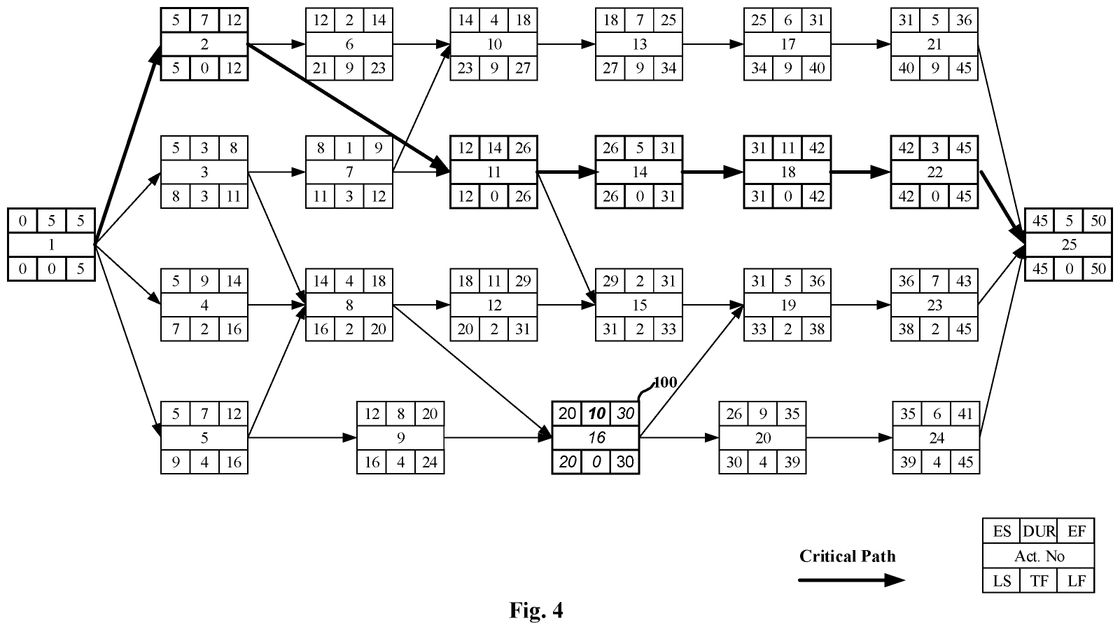

The present invention will now be described by using two examples. FIG. 3. illustrates a CPM network, including 25 activities. The ES, EF, LS, LF, dates and TFs of activities are calculated using traditional forward and backward pass calculations. The first example describes the method of the invention in which the duration of Activity-16 is increased to ten days from its original duration of six days. Referring to FIG. 4, the method of the invention first determines the updated EF of the activity as 30, by adding the revised duration to its ES time of 20, in the partial forward pass. Since the updated EF of the Activity-16 (30) is not later than its LF (30), the method of invention can be used to update the schedule. The method then updates the LS of the activity as 20 by subtracting the revised duration from its LF time of 30 as marked with a in FIG. 4. The updated TF of the Activity-16 is calculated as zero, by subtracting its updated EF of 30 from its LF of 30. Since the updated TF of the activity is zero, Activity-16 is determined as a critical activity.

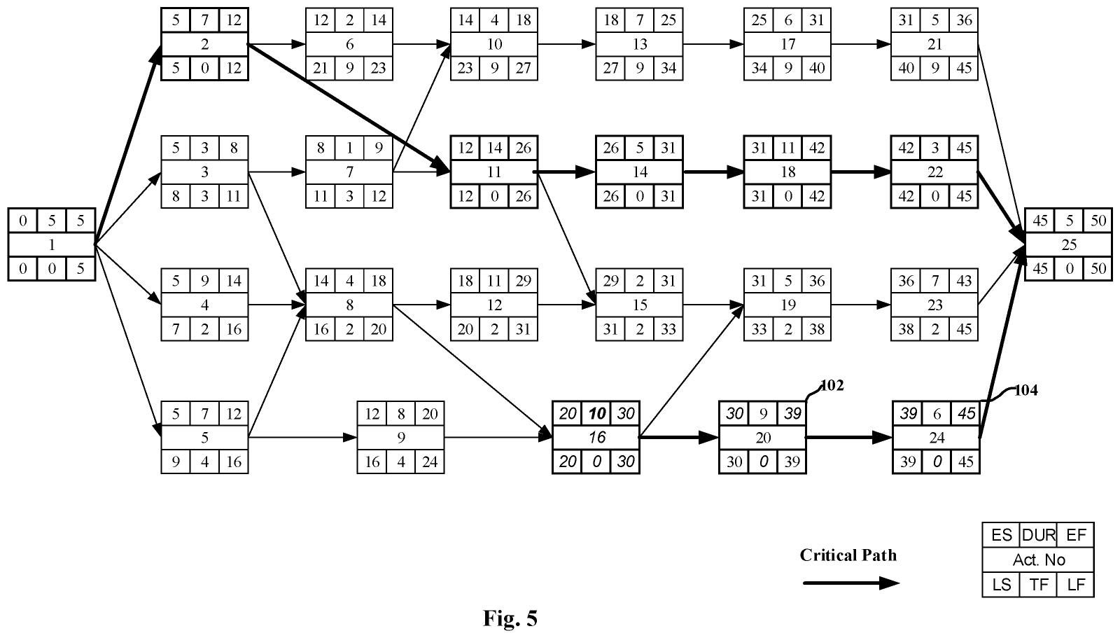

Activity-20, which is the successor of Activity-16 is added to the ATRS list, since it has an ES date of 26 that is earlier than the updated EF date of Activity-16 (30), and Activity-16 is removed from the list. The partial forward pass is continued, by updating the ES of Activity-20 as 30, so that it starts immediately after the updated EF time of the Activity-16, as shown by b in FIG. 5. The EF of the Activity-20 is updated by adding its duration of nine to its updated ES. The updated TF of Activity-20 is calculated as zero, by subtracting its updated EF of 39 from its LF of 39 and Activity-20 is also included in the critical path.

Activity-24, which is the successor of Activity-20 is added to the ATRS list, since it has an ES date of 35 that is earlier than the updated EF date of Activity-20 (39), and Activity-20 is removed from the list. The ES of Activity-24 is updated as 39 so that it starts immediately after the updated EF time of the Activity-20, as shown by c in FIG. 5. The EF of the Activity-24 is updated by adding its duration of six to its updated ES. The updated TF of Activity-24 is calculated as zero, by subtracting its updated EF of 45 from its LF of 45 and Activity-24 is also included in the critical path. Since Activity-25 which is the only successor of Activity-24, has an ES date of 45 that is not earlier than the updated EF date of Activity-24 (45), partial forward pass is completed.

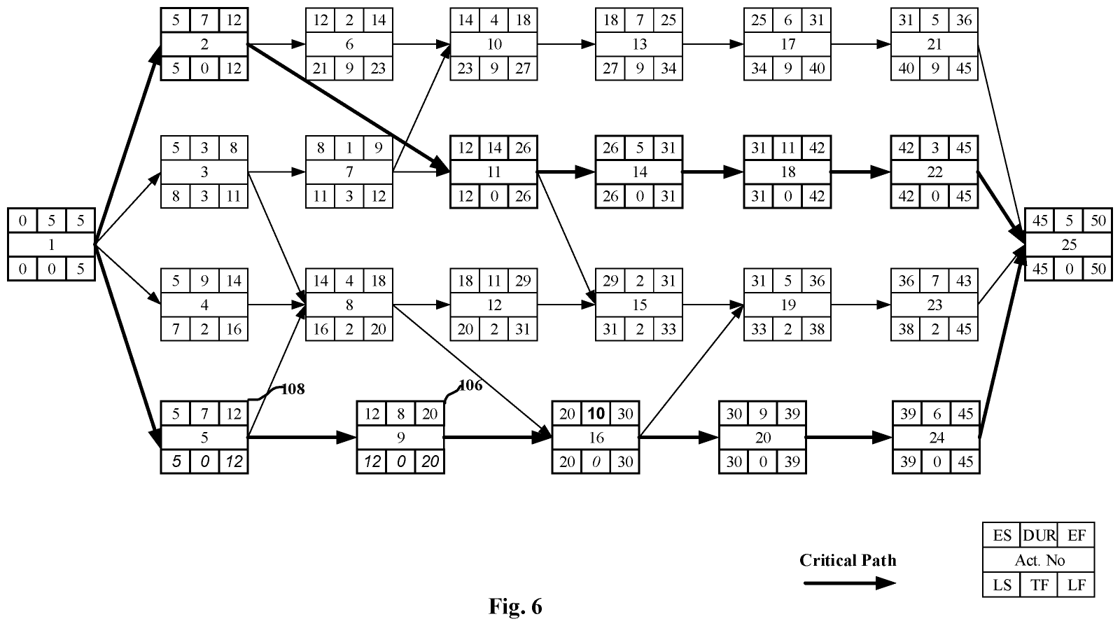

In the partial backward pass, Activity-9 is added to the ATRS list first, since it has an LF date of 24 that is later than the updated LS date of Activity-16 (20). The LF of Activity-9 is updated as 20, so that it does not finish later than the updated LS time of the Activity-16, as shown by d in FIG. 6. The LS of the Activity-9 is updated by subtracting its duration of eight from its updated LF. The updated TF of Activity-9 is calculated as zero, by subtracting its EF of 20 from its updated LF of 20 and Activity-9 is also included in the critical path.

Activity-5 is added to the ATRS list next, since it has an LF date of 16 that is later than the updated LS date of Activity-9 (12), and Activity-9 is removed from the list. The LF of Activity-5 is updated as 12, so that it does not finish later than the updated LS time of the Activity-9, as shown by e in FIG. 6. The LS of the Activity-5 is updated by subtracting its duration of seven from its updated LF. The updated TF of Activity-5 is calculated as zero, by subtracting its EF of 12 from its updated LF of 12 and Activity-5 is also included in the critical path. Since Activity-1 which is the only predecessor of Activity-5, has an LF date of 5 that is not later than the updated LS date of Activity-5 (5), partial backward pass is completed.

The first example illustrates that the invention performs rescheduling of non-critical activities by only performing partial scheduling of five activities (Activities 16,20,24,9,5) when the duration of Activity-16 is changed to 10 days. Traditional critical path method will require full scheduling of all of the 25 activities to reschedule the non-critical activities, when the duration of Activity-16 is changed to 10 days. Hence, the example illustrates the effectiveness of the invention when the duration of a non-critical activity is changed and the change does not increase the project duration.

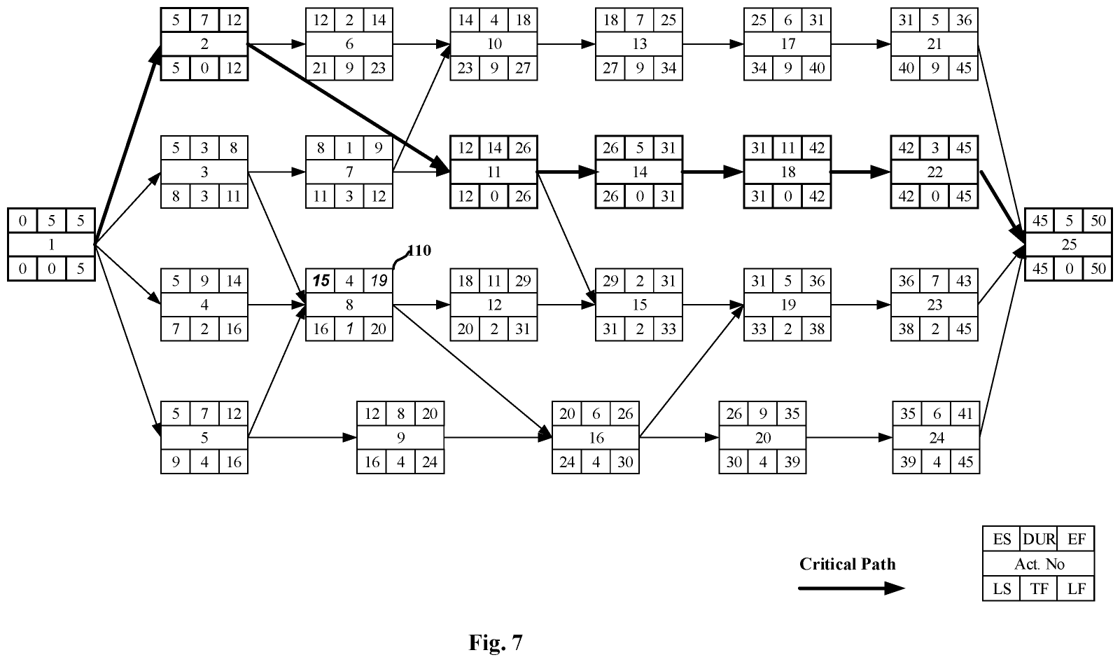

The second example describes the method of the invention in which start time of Activity-8 is shifted from its ES time of 14 to a start time (ST) of 15 for the schedule shown in FIG. 3. The method of the invention first determines the updated EF of the Activity-8 as 19, by adding the its duration (4) to its ST time of 15, in the partial forward pass as shown by a in FIG. 7. Since the updated EF of the Activity-8 (19) is not later than its LF (20), the method of invention can be used to update the schedule. The updated TF of the Activity-8 is calculated as one, by subtracting its updated EF of 19 from its LF of 20.

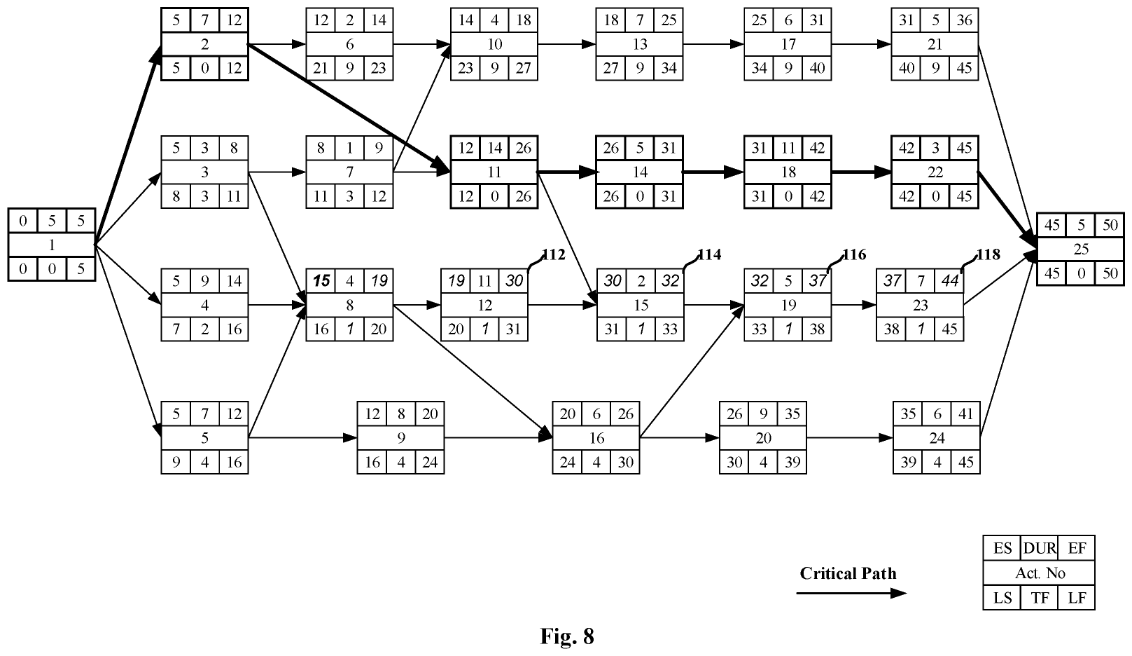

Activity-12, which is the successor Activity-8 is added to the ATRS list, since it has an ES date of 18 that is earlier than the updated EF date of Activity-8 (19), and Activity-8 is removed from the list. The ES of Activity-12 is updated as 19 so that it starts immediately after the updated EF time of the Activity-12, as shown by b in FIG. 8. The EF of the Activity-12 is updated by adding its duration of 11 to its updated ES. The updated TF of Activity-12 is calculated as one, by subtracting its updated EF of 30 from its LF of 31.

The partial forward pass is continued, by updating the ES of Activity-15 as 30, and its EF as 32 and its TF as 1, as shown by c in FIG. 8. Similarly, the ES, EF, and TF values of Activity-19, and Activity-23 are updated as shown by d and e in FIG. 8, respectively. Since Activity-25 which is the only successor of Activity-23, has an ES date of 45 that is not earlier than the updated EF date of Activity-24 (44), partial forward pass is completed.

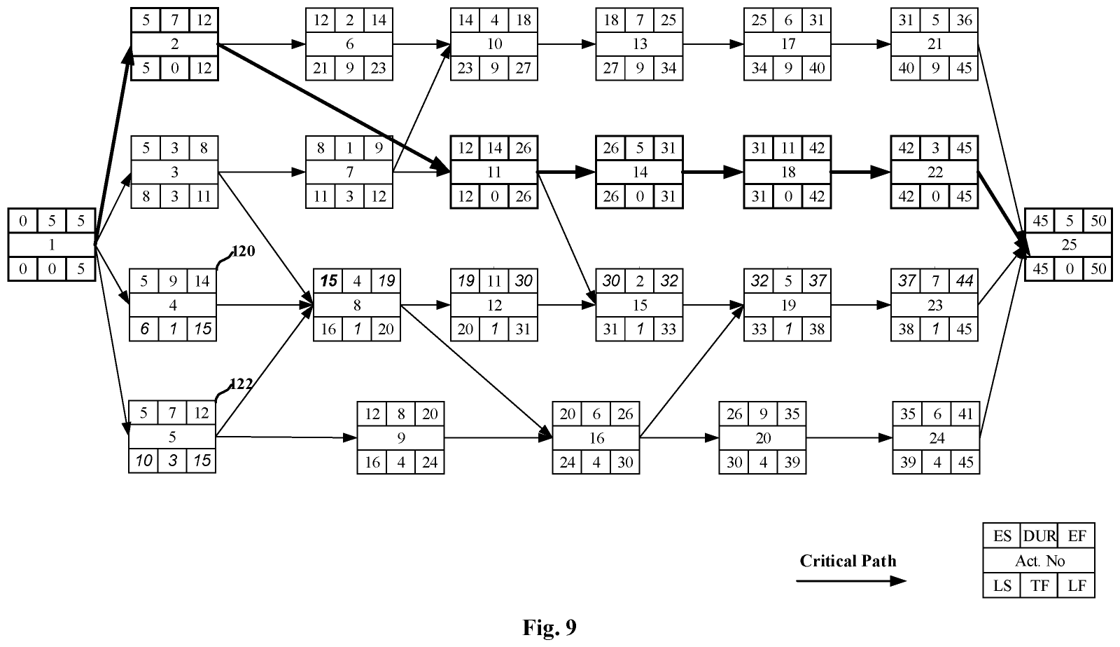

In the partial backward pass, Activity-4, and Activity-5 are added to the ATRS list, since both have a LF date that is later than the updated start time of Activity-8. The LF of Activity-4 is updated as 15, so that it does not finish later than the updated start time of the Activity-8, as shown by f in FIG. 9. The LS of the Activity-4 is updated by subtracting its duration of nine from its updated LF. The updated TF of Activity-4 is calculated as one, by subtracting its EF of 14 from its updated LF of 15. Similarly, the LS, LF, and TF of Activity-5 are updated as 15,10, and 3 as shown by g in FIG. 9. Since Activity-1 which is the only predecessor of Activity-4 and Activity-5, has an LF date of 5 that is not later than the updated LS date of Activity-4 (5) and Activity-5 (5), partial backward pass is completed.

The second example illustrates that the invention performs rescheduling of non-critical activities by only performing partial scheduling of seven activities (Activities 8,12,15,19,23,4,5) when the start time of Activity-8 is shifted to 15. Traditional critical path method will require full scheduling of all of the 25 activities to reschedule the non-critical activities, when the start time of Activity-8 is shifted to 15. Hence, the second example illustrates the effectiveness of the invention when the start time of a non-critical activity is changed and the change does not increase the project duration.

The two examples described above, demonstrates that the present invention significantly improves the scheduling process of non-critical activities, when there is a change in the duration or the start time of a non-critical activity, and the change does not increase the project duration. The main advantage of the method of the present invention is that it only reschedules the non-critical activities that are impacted by a duration change or a start time shift, hence shortens the scheduling calculations significantly. The method also shortens scheduling calculations further by only calculating the start and finish dates that are impacted by the schedule change. The method of the present invention presents a detailed scheduling technique that has major advantages for resource leveling, cash flow management, time-cost trade-off analysis and for similar problems of project management in which rescheduling of non-critical activities are required.

What is claimed is:

1. A computerized scheduling method for rescheduling of the non-critical activities in a schedule when the duration or start time of a non-critical activity (or multiple non-critical activities) is changed and the change does not increase the project duration, comprising the steps of:
partial rescheduling (updating) of the activity for which the duration or start time has changed;
determining the non-critical successors of the rescheduled activity that are impacted by the schedule update, and including these successors in the activities to be rescheduled (ATRS) list;
performing partial forward pass scheduling by updating the ES, EF, and the TFs of all succeeding activities that are included in the ATRS list, including the activities with an updated total float of zero in the critical path, and updating the ATRS list so that it will only include the successors of the previous ATRS list with an ES earlier than the updated EF of the preceding activity;
repeating the partial forward pass procedure until all the succeeding activities that are impacted by the schedule change are updated;
determining the non-critical predecessors of the rescheduled activity (for which the duration or start time has changed) that are impacted by the schedule update, and including these predecessors in the activities to be rescheduled (ATRS) list;
performing partial backward pass scheduling by updating the LF, LS, and the TFs of all predecessor activities that are included in the ATRS list, including the activities with an updated total float of zero in the critical path, and updating the ATRS list so that it will only include the predecessors of the previous ATRS list with a LF later than the updated LS of the of the preceding activity;
repeating the partial backward pass procedure until all the preceding activities that are impacted by the schedule change are updated.

2. The method of claim 1, wherein more than one non-critical activity is rescheduled by applying the method several times.

3. The method of claim 1, wherein there are resource constraints.

4. The method of claim 1, wherein the precedence relations include start-to-start, finish to start, and start to finish.

5. The method of claim 1, wherein the precedence relations include minimum and maximum time lags.

6. The method of claim 1, wherein the progress of the activities within time are linear.

7. The computer program product of claim 1, further comprising computer-usable program code for rescheduling of the non-critical activities in a schedule.
